(19) United States
(12) Patent Application Publication
(10) Pub. No.: US 2008/0233327 A1
(43) Pub. Date: Sep. 25, 2008

(54) PRINT MEDIA HAVING DETACHABLE CARDS AFFIXED THERETO AND METHOD FOR FORMING THE PRINT MEDIA

(76) Inventor: Peter R. Hudetz, Naperville, IL (US)

Correspondence Address: BRINKS HOFER GILSON & LIONE, P.O. BOX 10395, CHICAGO, IL, 60610, US

(21) Appl. No.: 12/046,230

(22) Filed: Mar. 11, 2008

Related U.S. Application Data
(60) Provisional application No. 60/919,060, filed on Mar. 19, 2007.

(51) Int. Cl. B32B 3/10; B65D 65/28

(52) U.S. Cl. 428/43; 156/250

(57) ABSTRACT

Print media having detachable cards affixed thereto and method for forming the print media including providing a first preprinted roll of web paper having a first thickness and providing a second preprinted roll of web paper having a second thickness, where the first the thickness is greater than the second thickness. Customer information is imaged or applied on a first ribbon of the first roll of preprinted web paper and die cut into cards which are glued to a second ribbon of the second preprinted roll of web paper which is also contains printed information and the second ribbon is separated into sections where each section includes a card glued thereto. The first roll of web paper is a single layer stock paper of the first thickness.

### PRIORITY CLAIM

This application claims priority to U.S. Provisional Patent Application Ser. No. 60/919,060, filed Mar. 19, 2007, the disclosure of which is incorporated by reference herein.

### TECHNICAL FIELD

The present invention relates, generally, to in-line finishing systems and methods for manufacturing direct-mail print media and, more particularly, to systems and methods for forming print media having detachable cards affixed thereto.

### BACKGROUND

Advertising for direct-mail advertisements can be provided in the form of multiple printed pages of advertising. As a further means of advertising and product promotion, these materials often include a detachable portion that can be used by the consumer at retail establishments. The detachable portion can be used by the consumer to obtain price discounts for merchandise, gifts, additional merchandise, temporary memberships, and the like. Typically, the detachable portions are formed in the shape of a card, such as a credit card, or a business card. In order to collect marketing information identifying the individual customers, the cards are imaged with a bar code to provide customer information in a scan-readable format. Also, magnetic strips can be attached that are encoded to establish value, and to track customer information. When the card is used by the customer at a business establishment, the customer's information is scanned or read from the card and transferred to a computer, then transmitted to the retailer, the supplier, or to a marketing company.

Typically, the advertising flyers with attached cards are made by printing information onto rolls of paper that are subsequently processed to form cards and the cards are glued onto a larger sections of paper. In one such process described in U.S. Pat. No. 7,017,899, the cards are formed by slitting a preprinted web into at least three separate ribbons. At least two of the ribbons are glued together to form a multi-ply ribbon, which is then cut and attached to the third ribbon. In this way, a removable portion is formed that has a greater thickness than the sheet that supports the removable portion. Alternatively, other processes include the formation of separate ribbons that are printed in one or more web presses and subsequently glued together to form multi-page inserts. In one such process described in U.S. Pat. No. 6,712,398, booklets or leaflets are prepared by folding web paper multiple times to form a number of overlaying sheets that are subsequently bound to form a spine. The booklet is then brought together with a substrate sheet and the booklet is glued onto the substrate.

In both of the process method described above, a multi-ply removable portion is prepared and attached to a substrate or host ribbon that is subsequently sectioned into smaller portions. Such processes tend to be complicated and require numerous additional processing steps to either slit and align ribbons of a single web, or prepare bindings for multi-page leaflets. The existing methods offer opportunity for improvement in efficiency and increased production capacities. Accordingly, a need exists for an efficient high volume method for producing print media having detachable cards.

### BRIEF SUMMARY

In one embodiment, a method for forming print media having detachable cards includes providing a first preprinted roll of web paper having a first thickness. A second preprinted roll of web paper is provided having a second thickness, where the first thickness is greater than the second thickness. Customer information is imaged on a first ribbon of the first roll of web paper and a UV coating is applied to the first ribbon. The first ribbon is then cut to form cards and the cards are glued to a second ribbon of the second preprinted roll of web paper. The second ribbon is separated into sections where each section includes at least one card glued thereto.

In another embodiment of the invention, a print media having a detachable card affixed thereto includes a carrier sheet having a first thickness and including preprinted information. A preprinted card having a second thickness adheres to the carrier sheet. The card includes customer information imaged thereon and is a single layer stock paper of the second thickness, where the second thickness is greater than the first thickness.

### BRIEF DESCRIPTION OF THE DRAWING

FIGS. 1-2 schematically illustrate initial process steps for a card web in accordance with an embodiment of the invention;

FIG. 3 schematically illustrates initial processing steps for a carrier web in accordance with an embodiment of the invention; and

FIG. 4 schematically illustrates processing steps for joining the card web and the carrier web and sectioning the carrier web.

### DETAILED DESCRIPTION

In one embodiment, the process of the present invention can be carried out to form direct mail advertising materials. The advertising material typically includes information printed on a flyer, which can be one or more sheets of paper having text and images printed on the one or both sides of the paper. The flyer also has a card attached to one of the sheets, which can be detached from the flyer. The card is small relative to the size of the flyer and is made of thick paper, such that the card has the approximate size and shape of a business card or credit card. The card can be used by the customer to obtain promotional offers at a retail store or other business establishment. Information identifying the individual customer in a scanner-readable format is encoded or imaged on the card. When the card is used at a business establishment, the customer's information is scanned into a computer and transmitted to any of a number of business entities, such as the retailer, a supplier, or a marketing company.

The inventive process forms the cards using a relatively thick paper web, which can be a 24pt paper web. The cards are attached to a carrier, which is made from thinner paper, such as a 7pt paper web. This type of process is known in the industry as an “off-line finishing process,” because the paper web is provided in pre-printed rolls, which are subsequently processed into a finished product. The card web can be printed in a separate printing press from the carrier web, or both the card web and the carrier web can be printed in the same printing press at different times. The card web is a single layer of thick paper and is not formed from multiple layers secured together.

In a preferred method, the card web is printing in a flexographic printing process in which the card web is processed from a web of thick, single-layer card stock. In the inventive process, once the thicker web is processed to produce cards, the carrier web is brought together with the card web and the cards are glued to the carrier. The carrier is cut apart in sections where each section contains a card glued to the carrier section. The carrier sections can then be used as direct mail pieces, or further processed to form specialized advertising materials.

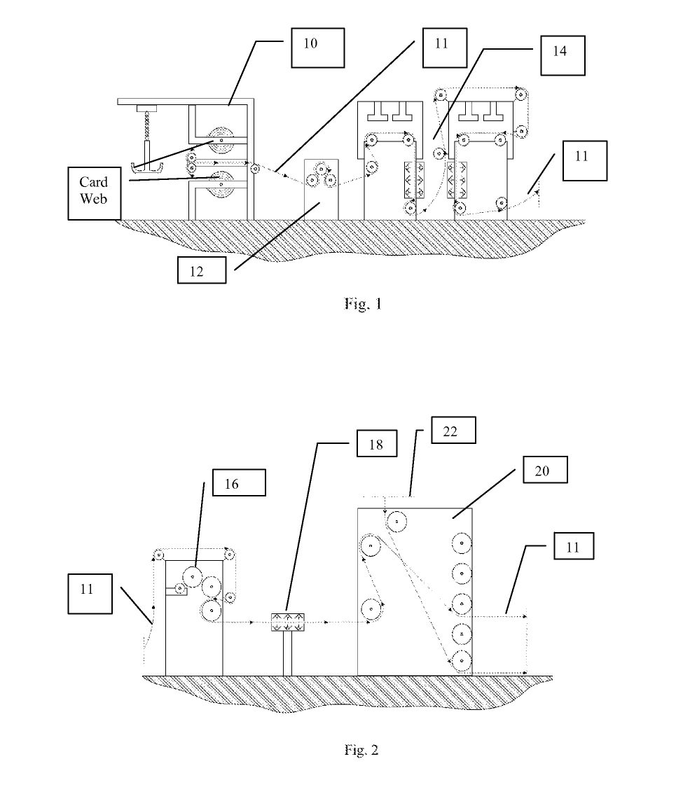

One embodiment of the inventive process is illustrated in a series of figures depicting various stages of the card manufacturing process and the carrier manufacturing process. In FIG. 1, the initial processing of the card is illustrated in which pre-printed rolls of the card paper web are processed through an imaging system. The card web is a thicker paper stock that can be provided in sufficient firmness and thickness to simulate a business card, or a plastic card, such as credit card or gift card.

As illustrated in FIG. 1, the card web rolls are placed in position on an unwind station, or what is commonly referred to as an in-register splicer (10). The rolls of card paper web stock can include printed information that is applied by a roll-to-roll flexographic, roll-to-roll off-set printing press, or variable data print engine (not shown) prior to mounting the rolls on the in-register splicer. The card paper web (11) is unwound from the splicer (10) and transported by an infeed system (12) to an imaging tower (14). Although two rolls are mounted in the splicer, in a typical process, only one roll is fed out until it is depleted and then the second roll is spliced into the infeed system.

In the imaging tower (14), the card paper is printed with personalized information by a variable data ink-jet printing system. In the imaging tower, an ink jet head prints various types and formats of information on the web. The information can include barcodes, individual names, numbers, and the like. The information is correlated to a database that contains additional marketing information about the individual customers who will receive the cards as direct mail promotional offers. The ink jet system illustrated above has two imaging stations and prints information on both sides of the card web. The imaging tower used in the off-line card process is manufactured by Jet Web Finishing Systems of Avon, Mass. Alternatively, a magnetic strip can be programmed and attached to the card web in an appropriate location.

Once the card web is ink jet imaged in the imaging tower it moves through a UV coating process. As illustrated in FIG. 2, the web is transported through an ultra-violet coating station (16) that applies a protective clear UV coating over the images printed on the web.

The UV coating prevents scuffing of the ink jetted images and can help make the paper cards appear to be made from a plastic material. Although a UV coating described above is applied to one side of the web, the off-line card process can also be operated with two units to coat both sides of the web. The UV coating system is manufactured by Jet Web Finishing Systems of Avon, Mass. After coating, the web is transported through a dryer (18) fitted with UV curing lamps and into a ribbon deck (20).

In an alternative embodiment, instead of, or in addition to, imaging the card web, a magnetic strip can be attached to card web. If a magnetic strip is used exclusively, the card web does not require the UV coating for protection.

As noted above, the carrier is made from a carrier paper web that is thinner than the card web. In the off-line card process, a variety of paper thicknesses are used, but preferred embodiments, the paper web material forming the card is a thicker paper stock than the carrier paper web.

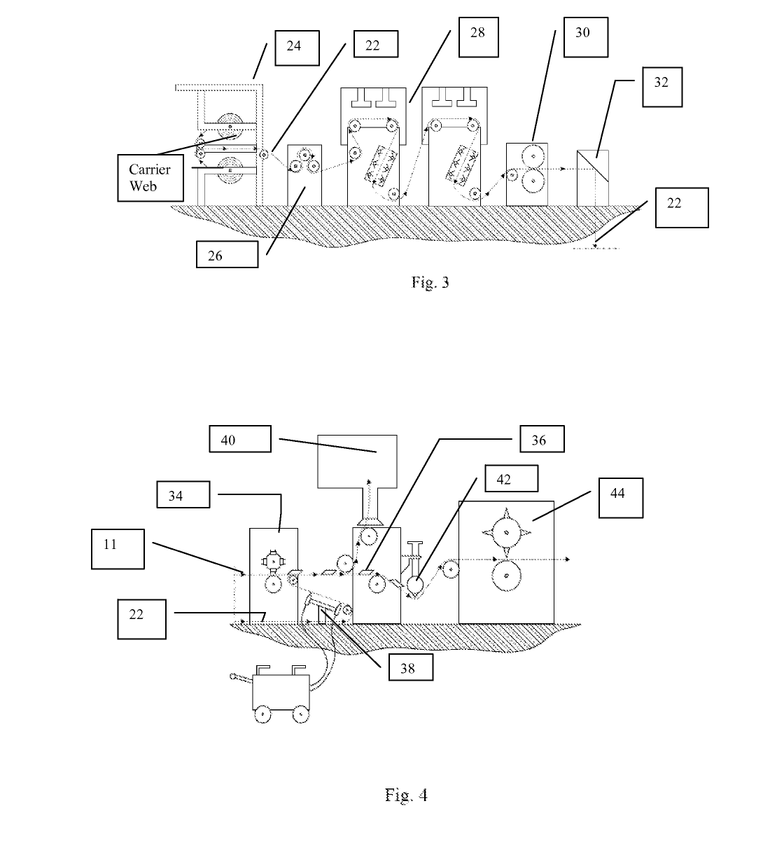

The initial processing of the carrier web (22) is illustrated in FIG. 3. In the carrier web line, carrier web rolls are placed in an in-register splicer (24) and sequentially unwound from the splicer (24) by an infeed system (26), then transported to an imaging tower (28) for printing desired images on the carrier web. After imaging, the carrier web can be perforated in a perforating machine (30) so that the portions of the carrier web can be easily separated when received by the consumer. After perforating, the carrier web may be redirected by a turning device (32) and transported to the ribbon deck (20) shown in FIG. 2.

In the ribbon deck, both the card web (11) and the carrier web (22) are simultaneously, but separately processed. At the process stage shown in FIG. 2, the carrier web has already undergone a series of process steps that will subsequently be described below in connection with FIG. 3. In accordance with various preferred embodiments, the card web can undergo a variety of process steps in the ribbon deck depending upon the particular application. Both the carrier web and the card web are available in a large range of widths. In one alternative embodiment, the card web remains as a single ribbon that is subsequently married to the carrier web. In another alternative embodiment, the card web is cut into multiple ribbons depending upon the width of the carrier web. For example, where the carrier web is a 36″ wide web, the carrier web can be slit into ribbons and the ribbons shifted to overlay one another, or 36″ wide web can be folded down multiple times to create one mailing piece. In this case, the card web is 4″ wide and one card is affixed to the carrier web, which is then folded. In yet another embodiment, a 36″ wide carrier web is slit into three ribbons having a width of 12″ each, and the card web having a width of 12″ is slit into three ribbons of 4″ width each and aligned with the three carrier ribbons to create three streams of mail pieces. These and other process variations can be performed using a ribbon deck manufactured by Jet Web Finishing Systems of Avon, Mass.

Once the card web and the carrier web are aligned by the ribbon deck, portions of the card web are cut by a cutting die to define the cards within the streaming ribbon of the card web. The cards can have a variety of dimensions depending upon the particular customer requirements being served by the inventive process. As shown below in FIG. 4, a die-cutter (34) rotates against a hardened cylinder and cuts a series of card-shaped portions into the 24 pt web (11). The cards (36) are sized by the die to the final desired card size and are subsequently attached to the carrier web (22). The carrier web (22) travels under the die-cutter (34) and past gluing system (38). The gluing system applies hot melt glue spots to the carrier web to provide an adhesive surface for attachment of the cards. The carrier web is then mated up with the die cut cards web, such that the cards are in the proper position relative to the carrier web, and the cards (36) are attached to the carrier web (22). The waste matrix of the remaining 24 point card stock is evacuated into a waste removal system (40).

After removing the waste matrix, the carrier web is folded one or more times by a folding system (42), then glued in a hot melt glue system (not shown) and cut into sections by a rotary cutter (44). In a preferred embodiment, the die cutter is manufactured by Jet Web, and the gluing systems are manufactured by Nordson Corp. of Duluth, Ga.

In another embodiment of inventive process, the cards are die cut and slit from the card web and accelerated to join the carrier web and positioned at the appropriate location on the carrier web. This process is preferably carried out with a Jet Web die cutter, a Jet Web slitter, and a Jet Web Accelerator section (not shown). With either method, one or more cards can be attached to each section of the carrier web.

To maximize the use of available floor space, the inventive process can be carried out with a variety of equipment floor arrangements. In particular, the carrier line illustrated in FIG. 3 can be arranged on the shop floor in a variety of positions relative to the card line illustrated in FIGS. 1 and 2. For example, the carrier line can be arranged in parallel to the card line, one behind the other, or arranged at a right angle to the card line. In both cases, appropriate equipment is used to redirect the flow of the card web and the carrier web as necessary to accommodate the floor arrangement. One such arrangement is illustrated in the schematic diagram of FIG. 5. In this diagram, the carrier web is processed in the equipment line labeled “MAIN LINE,” and the card is processed in the equipment line labeled “CARD LINE FAN LINE.” Additional equipment is included to redirect the flow of the carrier web and the card web; however, the process operations are the same as described above. Other equipment arrangements for the inventive process are possible and can include the use of additional equipment to redirect the flow of the carrier and card webs on the shop floor.

In an alternative method, the cards can be prepared by imaging information or by attaching magnetic strips onto the card web and then preparing rolls of card web. This can alter or eliminate the need for imaging the card web prior to attaching the cards to the carrier web. For example, the pre-processed card web is placed in the in-register splicer (10) and fed to the ribbon deck (22) and into the die-cutter (34). This alternative can eliminate the need for processing of the card web (11) in the imaging tower (14). In a similar manner, the carrier web can be entirely pre-printed and rolls of pre-printed web feed directly to the die-cutter (34). This alternative can eliminate the need for processing of the carrier web (22) in the imaging tower (28).

Thus it is apparent that there has been described a system and method for forming print media having detachable cards affixed thereto that fully provides the advantages set forth above. Those skilled in the art will recognize that numerous modifications and variations can be made without departing from the spirit of the invention. Accordingly, all such variations and modifications are within the scope of the appended claims and equivalents thereof.

1. A method for forming print media having detachable cards, the method comprising:
providing a first preprinted roll of web paper having a first thickness;
providing a second preprinted roll of web paper having a second thickness, wherein the first thickness is greater than the second thickness;
treating the first roll of web paper to add customer information on a first ribbon of the first roll of web paper;
applying a UV coating to the first ribbon and cutting the first ribbon to form cards;
gluing the cards to a second ribbon of the second preprinted roll of web paper; and
separating the second ribbon into sections,
wherein each section includes at least one card glued thereto.

2. A print media having detachable cards affixed thereto, the print media comprising:
a carrier sheet having a first thickness and including preprinted information;
a preprinted card having a second thickness adheres to the carrier sheet,
wherein the card includes customer information thereon and comprises a single-layer stock paper of the second thickness, and wherein the second thickness is greater than the first thickness.
